(19) United States
(12) Patent Application Publication
(10) Pub. No.: US 2004/0021726 A1
(43) Pub. Date: Feb. 5, 2004

(54) Cleaning unit for an inkjet printing device

(76) Inventors: Franz Obertegger, Brixen (IT); Herbert Gasser, Brixen (IT); Josef Saboi, Ranggen (AT)

Correspondence Address: WILLIAM COLLARD, COLLARD & ROE, P.C., 1077 NORTHERN BOULEVARD, ROSLYN, NY, 11576, US

(21) Appl. No.: 10/380,659

(22) PCT Filed: Dec. 29, 2000
(86) PCT No.: PCT/EP00/13333

(30) Foreign Application Priority Data
Sep. 15, 2000 (IT) BZ2000A000038

(51) Int. Cl. B41J 2/165

(52) U.S. Cl. 347/29

(57) ABSTRACT

A cleaning unit (10) for an ink jet printer has a suction and parking cap (16) with an orifice (18), which can be placed on a print head in order to totally prevent any light from getting in.

### TECHNICAL BACKGROUND

The invention relates to a cleaning unit for an ink jet printer of the type outlined in the generic part of claim 1.

A problem which occurs with ink jet printers is that ink residues inevitably accumulate at the outlet nozzles and in the area around them on the print head. If left long enough for the solvent contained in them to evaporate, these ink residues can harden. Furthermore, if using ink which is curable by UV light, the ink residues will harden on exposure to light. If this happens, the operating safety of the ink jet printer can not be guaranteed to a satisfactory degree of reliability because the outlet nozzles can become clogged, which will have an adverse effect on the print quality.

### THE PRIOR ART

A cleaning unit of the type described in the introductory part of claim 1 is known from patent specification DE 40 00 416 A1. In order to ensure problem-free operation by cleaning the print head on a regular basis, a suction and cover cap is placed on the print head, ink is sucked off the print head and the print head wiped by means of an appropriate device. Whilst this known device is capable of guaranteeing the operating safety of an ink print head which uses inks containing solvents, the use of ink which is curable by UV light poses a risk insofar as the ink residues can harden on the print head before they can be removed with the known cleaning device.

### DESCRIPTION OF THE INVENTION

The underlying objective of the invention is to propose a cleaning unit for an ink jet printer, which also ensures that the print head will be reliably cleaned, even if using ink of the type cured by UV light, and prevents incrustation on the print head.

This objective is achieved by the cleaning unit described in claim 1.

Accordingly, the cleaning unit proposed by the invention has a suction and parking cap with an orifice, which can be placed on a print head, totally preventing penetration by light. As a result, apart from being able to draw the ink off the print head to prevent incrustation of the nozzle outlets and any uncontrolled build-up of droplets on the nozzle outlet, this also prevents any light, in particular UV light, which would otherwise cause the ink residues to set and clog the nozzle outlets, from reaching the print head during the suction process. The feature of being able to place the print head against the orifice of the suction and parking cap in a manner which prevents light from penetrating it is assisted by the fact that appropriate materials and covers are used to ensure that no light is able to reach any ink residues which might cause the ink to set. For example, appropriate caps may be used so that no UV light can get to the print head when it moves from its “habitual” writing position to the cleaning unit. In this respect, it should be pointed out that for the purposes of the invention, an extended guide which is necessary for moving the print carriage can be used for a dual purpose. If using UV ink, the movement of the carriage needs to be extended at both sides so that the UV lamps mounted at the two sides of the print carriage can also fully illuminate the printed region. In other words, the print head must be moved slightly to the side, outside of the printed region, so that the UV lamp mounted on the print carriage can be disposed beyond the peripheral region of the area to which print has just been applied. Extended in this manner, a carriage guide can advantageously be used so that the print carriage, which can be moved beyond the peripheral region on at least one side, can be arranged on a cleaning unit as proposed by the invention.

To afford protection against exposure to UV light, both the actual cover cap which can be placed on the print head and all lines running to the orifice, which can be used to apply a vacuum in order to suck of the ink, are made from a material that is not transparent to light so that incident light which would cause the ink residues to dry on the print head can also be prevented here. It should be pointed out that in a preferred embodiment, the suction and parking cap, and preferably the entire cleaning unit proposed by the invention, is designed so that it can be raised, thereby enabling the orifice to be placed against the print head when the cap or the entire cleaning unit is raised. Alternatively, the cleaning unit could be fixed, in which case the print head would be designed so that it can be lowered onto the cleaning unit.

Preferred embodiments of the invention are described in the other claims.

In order to ensure that no undesirable ink or ink residues remain in the cleaning unit itself after cleaning the print head, it has proved to be of advantage to provide a cover on the cleaning unit. It is preferably motor-driven, so that it can be moved away from the cleaning unit to make the cleaning unit accessible to the print head or print heads when a cleaning operation is to be run. Alternatively, it would be conceivable to provide a stop on the cover, for example, so that the moving print head pushes the cover as it is moved towards the cleaning unit.

As mentioned above, the cleaning unit proposed by the invention, which is specifically designed for use with inks which cure under UV light, is designed to suck ink out of the ink print head. Accordingly, not only can the suction and parking cap with its orifice be placed against the print head so that it does not let light in, it also provides a hermetic seal so that a vacuum pressure can be applied for suction purposes. This being the case, it has been found to be of advantage to integrate a delay element of the first order into the hydraulic circuit used to generate the vacuum pressure. In other words, a system is proposed, which has a capacity and a nozzle capable of operating a first order delay element. Specifically, the first order delay element consists of a capacity provided in the form of a bottle for waste fluid. When a vacuum pressure is applied and prevails in a pressure tank, the system consisting of throttle and capacity has a delaying effect. At the start, ambient pressure prevails in the waste fluid bottle and the pressure in this bottle slowly drops, so that a vacuum pressure also gradually builds at the print head from which the ink is sucked. Even when the co-operating valve is shut off, the throttle delays the return to normal pressure in the waste fluid bottle. The advantages of this are as follows. A controlled rise and fall in pressure can be obtained, which prevents parts of the ink delivery system that are of a flexible design, for example the hoses, from contracting and then expanding during the suction process, which would cause air to be sucked into the lines, leading to undesirable bubbles in the nozzle or the lines. It should be pointed out that the feature described above does not have to be combined with the arrangement whereby the print head can be placed on the suction and parking cap to prevent light from getting in. In other words, the advantages of a delay element of the first order will still be obtained if used in conjunction with other cleaning units designed for solvent-based inks since, it advantageously prevents air from being sucked into the ink lines and causing bubbles.

To complete the process of cleaning the print head, it is preferable to provide a wiper unit with a deflector roll incorporating an absorbent cloth, preferably made from non-woven material, which can be raised and lowered. The procedure for cleaning the ink outlets is operated as follows. Firstly, the ink is sucked out of the print head in order to bring the nozzle outlets to a defined state with regard to the ink. The print head is then wiped by the wiper unit in order to wipe off any residues of ink which might still be present in the area around the ink outlets.

To this end, the system may be configured in such a way that the apex of the roll is disposed on the print head outlets in its wiping position. Consequently, the entire surface of the print head outlets will be in contact with it and the ink will be soaked up by the absorbent cloth. This ensures that the print head outlets are very reliably wiped. In particular, the cloth may be moved relative to the print head outlets so that the print head outlets are wiped to a certain degree. Alternatively, the print head and the cloth may be displaced simultaneously so that the cloth is fully in contact with the surface of the print head outlets but there is no relative displacement between the print head nozzles and the cloth, which is more gentle on the nozzles.

A particularly gentle yet effective cleaning of the print head outlets can be achieved in a preferred embodiment, in which the apex of the deflector roll is arranged laterally adjacent to the print head outlets. In this case, the surface of the print head outlets is not in full surface contact but the surplus ink is sucked away from the side, as it were.

By preference, the suction and parking cap of the cleaning unit proposed by the invention additionally has a second orifice, into which solvent can be introduced. This feature, which provides a particularly reliable way of “parking” the print head if using solvent-based inks, even for a longer period, because the print head outlets are rinsed with solvent, preventing the ink from setting. Although this feature is basically designed for use with solvent-based inks and has considerable advantages regardless of the feature of applying the print head against the suction and parking cap to keep out light, it is also an appropriate means of parking the print head if using inks which cure on exposure to UV light if a second orifice is provided, which can be filled with solvent. The reason for this is that standard inks which cure on exposure to UV light also contain volatile elements and they can also thicken if left exposed, even if they are protected from UV light. The described second orifice into which solvent can be introduced to enable solvent to be applied to the print head over a longer period of time will also prevent the print head outlets from becoming clogged. To be more specific, it is preferable in this case to provide a first pump, for what could be called the parking fluid, which pumps the parking fluid, in other words a solvent, out of the parking fluid tank into the cap. A second parking fluid pump is also provided, which pumps the spent parking fluid into a waste tank.

As regards the design of a second orifice in the suction and parking cap, it has been found to be of particular advantage if the cap is of a rotatable design so that one or the other orifice can be placed selectively on the print head. In other words, the cap is essentially a cube-shaped component and said orifices are provided in two different faces. Accordingly, one orifice used for suction purposes can be placed under a vacuum pressure, whilst solvent is introduced into the other orifice, which is separated from the first orifice. Alternatively, the two orifices may also naturally be provided adjacent to one another on a substantially plate-shaped suction and parking cap, in which case the cap may be of a displaceable design so that one or the other orifice may be placed on the print head.

### BRIEF DESCRIPTION OF THE DRAWINGS

The invention will be described in more detail below with reference to the embodiment illustrated as an example in the appended drawings. Of these:

FIG. 1 is a perspective view of the cleaning unit proposed by the invention;

FIG. 2 is a perspective, exploded diagram of the cleaning unit proposed by the invention without cover;

FIG. 3 is a perspective view of the cleaning unit proposed by the invention with two print heads arranged on it;

FIG. 4 is a perspective view of a wiper unit of the cleaning unit proposed by the invention; and

FIG. 5 is a hydraulic circuit diagram illustrating a layout used for the cleaning unit proposed by the invention as a means of sucking ink out of the print head.

### DETAILED DESCRIPTION OF PREFERRED EMBODIMENTS OF THE INVENTION

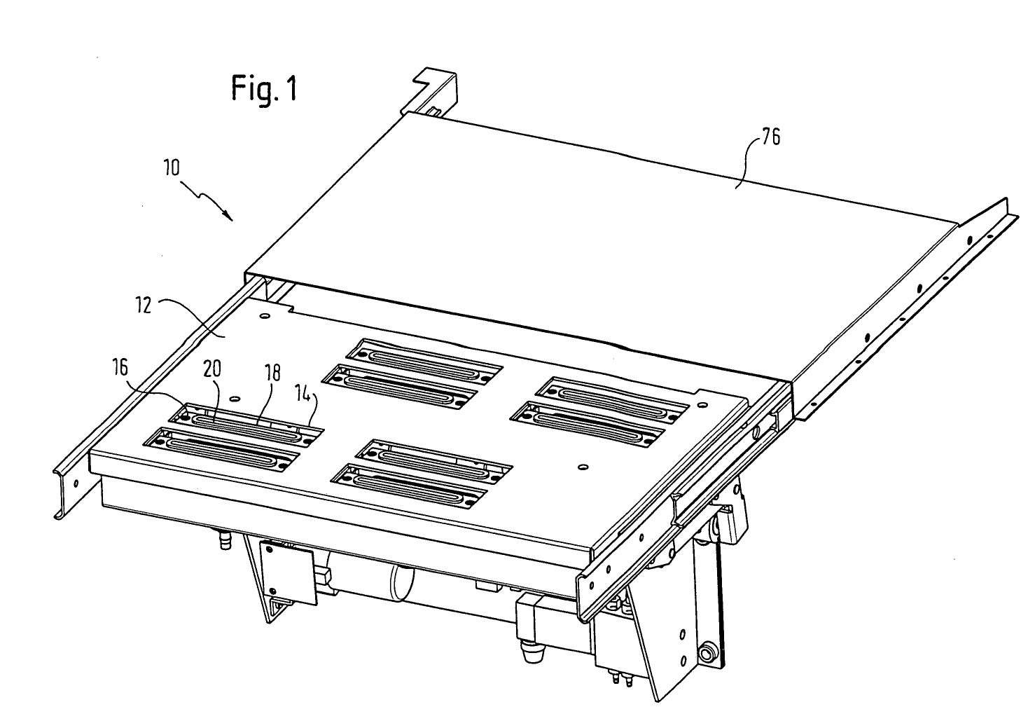

As illustrated in FIG. 1, a preferred embodiment of the cleaning unit 10 proposed by the invention has a cover 12, which has four pairs of slots 14, through which the suction and parking caps for the print heads, disposed underneath, are accessible. In the embodiment illustrated here, the cleaning unit 10 is an embodiment specifically designed for a four-colour printer, in which two print heads are provided for printing one colour and there are therefore four pairs of print heads.

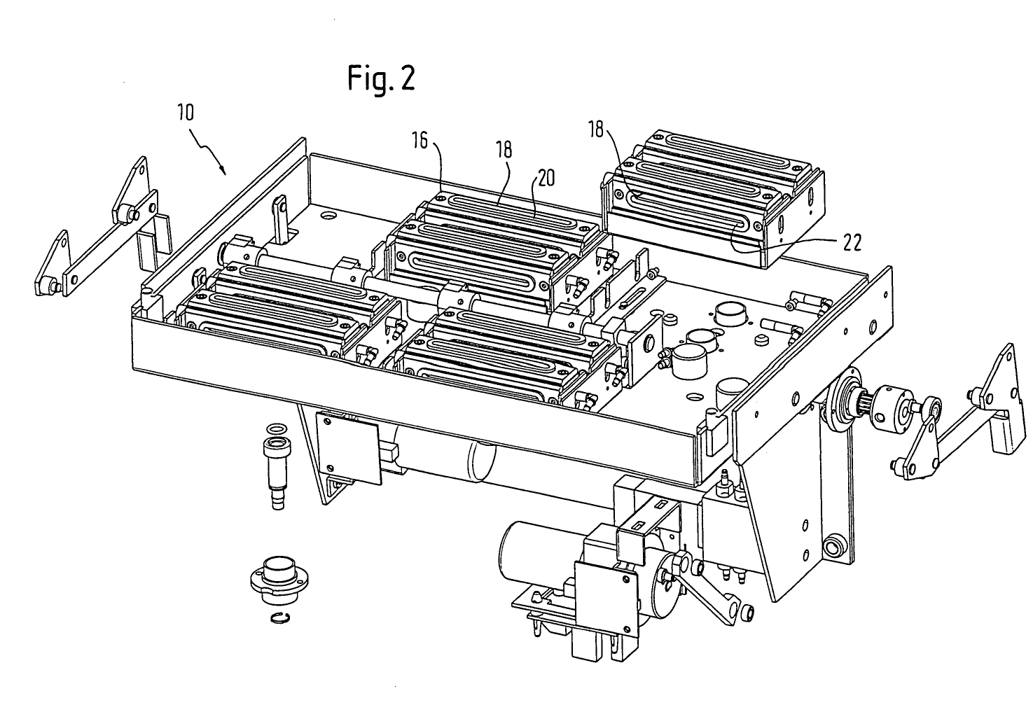

The cleaning unit 10 can be raised and lowered so that the print heads with their outlets are lowered through the slots 14 and placed against the respective suction and parking cap 16. In the embodiment illustrated here, two orifices are provided in every suction and parking cap 16. In the example illustrated, both orifices are provided with a sealing lip 18, which in the case of the orifice used for sucking ink out of the print head is necessary to ensure that the orifice is placed against the print head in a tight enough seal to allow the ink to be sucked out by a vacuum pressure. Hereafter, this orifice in the cap 16 will be referred to as “suction orifice” and denoted by reference 20. It is assumed that the suction orifice 20 is disposed on the top face when the respective caps 16 are oriented as illustrated in FIG. 1. The other orifice, which will be referred to as rinsing orifice 22 hereafter, is disposed on one of the sides of the cap 16 and may be seen in FIG. 2. In respect of FIG. 1, it should also be pointed out that a over 76 of a light-proof design is provided, motor driven or displaceable by means of the print carriage, so that the entire cleaning unit 10 can be covered without letting light in.

As may be seen from FIG. 2 in particular, the cap 16 is rotatable respectively about a horizontal axis so that one of the two orifices 20, 22 may be selectively placed at the top face enabling the cap 16 with this orifice to be placed on the print head. Although not illustrated in detail in FIGS. 1 and 2, the suction orifice 20 can be placed under a vacuum pressure by appropriate lines and such like, leading to a vacuum pressure source. A solvent delivery is also connected to the rinsing orifice 22 so that the print head placed against the orifice 22 can be rinsed with solvent during a longer period of non-operation. FIGS. 1 and 2 show other details of the cleaning unit proposed by the invention which are of no further relevance to an understanding of the invention. However, it should be pointed out that the cleaning unit 10 as a whole may be raised in order to apply all the caps 16 against the associated print heads simultaneously.

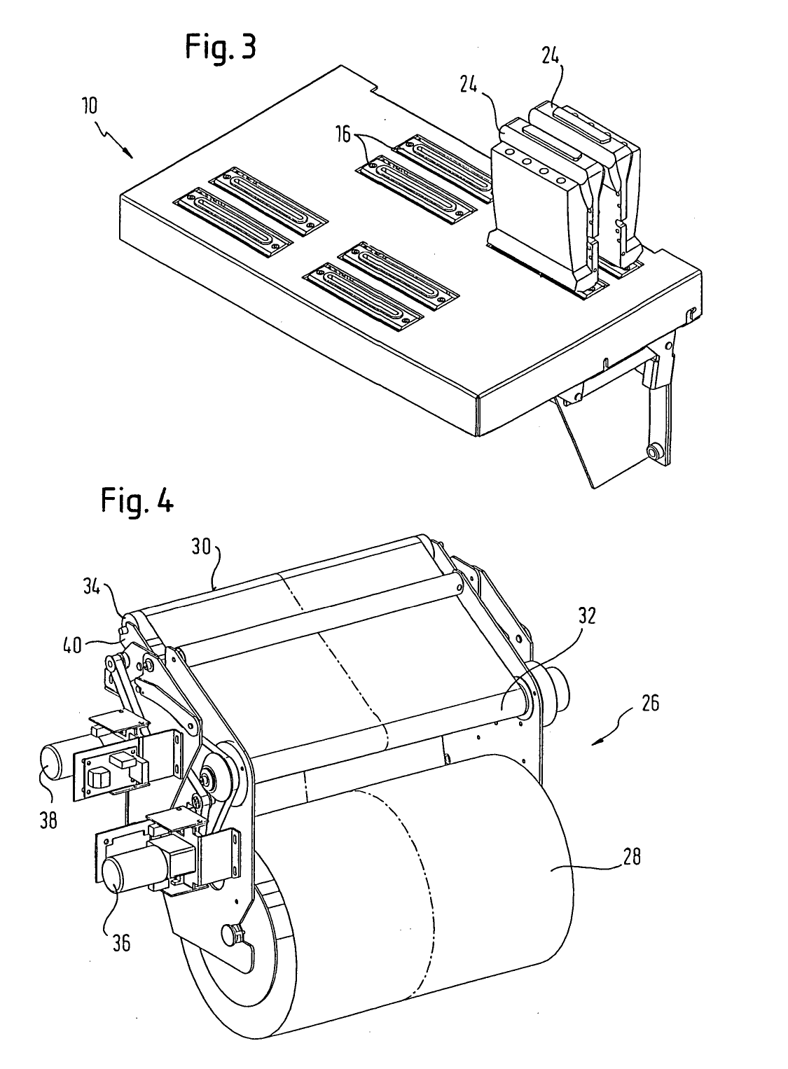

FIG. 3 illustrates such a position in the case of two print heads 24. Naturally, if the print heads are about to be cleaned, co-operating print heads 24 will also be placed on the other three pairs of suction and parking caps 16. Disposed against the bottom face (in the diagram illustrated in FIG. 3) of the print heads 24, is the respective surface of the print head outlet, which is disposed entirely within the orifice when placed against the respective orifice 20, 22, so that ink can be sucked out of all the print head outlets, which can also be closed off from the ambient environment preventing light from getting in, as proposed by the invention. When the print heads 24 are placed against the rinsing orifices 22, this orifice is also flooded with solvent so that any residues of ink remaining on the print heads 24 are dissolved, preventing any new incrustation from forming.

FIG. 4 illustrates a wiper unit 26 of the cleaning unit proposed by the invention. In the example illustrated here, the wiper unit 26 is an absorbent cloth wound onto a roller 28, which is guided via various rolls to an apex 30 of a deflector roll 34. The apex 30 may be disposed either on the surface of the print head outlets or slightly to the side, adjacent to it, in order to wipe ink residues off the print head outlets or absorb them by capillary action, the latter situation simultaneously being gentler on the print head outlets. A gentle cleaning action is also obtained if the apex of the cloth is applied flat against the surface of the print head outlets but the cloth is simultaneously displaced with the respective print head to be cleaned so that there is no relative displacement between said elements and the surface of the print head outlets is subjected to a gentle cleaning action. The respective portions of the used cloth are wound onto a roller 32. As may also be seen from FIG. 4, a motor 36 is provided, which is connected to the winding roller 32 by a belt drive. A motor 38 is also provided for raising and lowering the deflector roll 34, which is mounted on a pivotable arm 40 for this purpose.

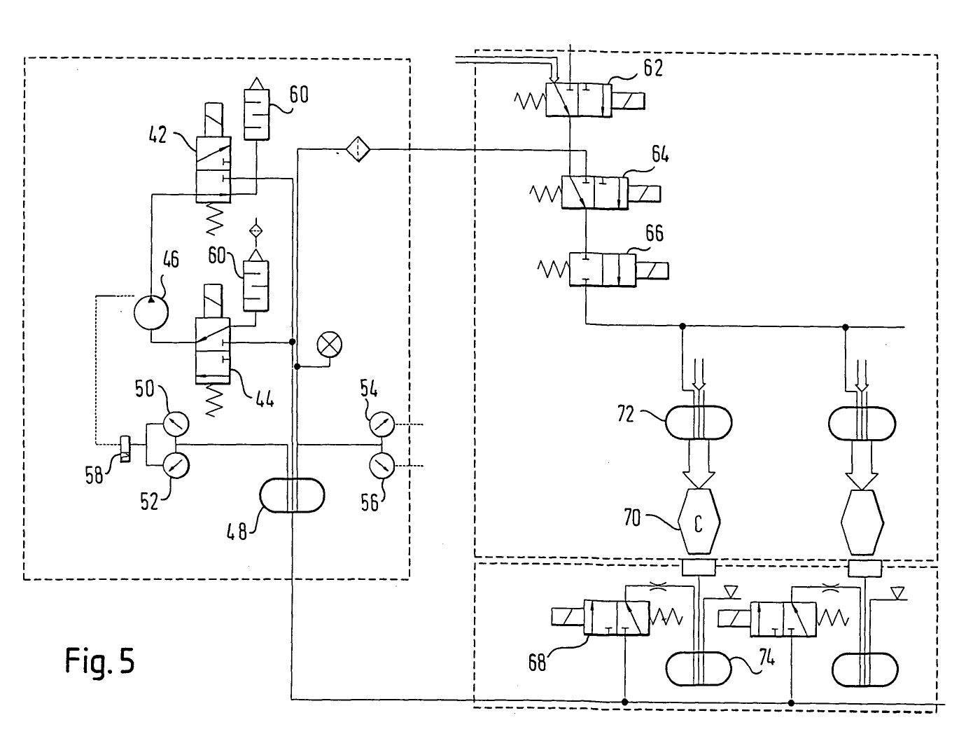

FIG. 5 illustrates an advantageous hydraulic circuit for operating a system which sucks ink out of the print heads. In particular, a first valve 42 and a second valve 44 is provided, which might be described as prime purge valves or suction/blower valves. In the non-energized state, the two valves 42, 44 are opened and connect the pump 46 to the ambient pressure. In this state, the pump 46 can be started. When the first valve 42 is energized, the pump generates a pressure above atmospheric pressure in the tank 48. When the second valve 44 is energized, on the other hand, the pump 46 generates a pressure below atmospheric pressure in the tank 48. As a result of the hysteresis of two pressure sensors, a blower pressure control sensor 50 and a suction pressure control sensor 52, the pressure can be kept constant by means of a two-point control. A blower pressure sensor 54 and a suction pressure sensor 56 are also provided for monitoring operation. A relay 58 is used to switch between the two operating modes, over pressure and vacuum pressure. A so-called “silencer” 60 connected respectively to the first valve 42 and the second valve 44 prevents any disruptive whistling noises.

A description will firstly be given of how a print head 70 is filled with ink. A first suction valve 62 is energized, a second suction valve 64 is not energized and an ink holding valve 66 is energized. Finally, a blower valve 68 co-operating with the print head 70 of the cleaning unit is energized. The ink is then drawn through the print head. Once the print head 70 has been filled, it is closed off by the mechanism (not illustrated) of the parking device and an over-pressure is generated in the tank 48 by switching between the first valve 42 and the second valve 44, an appropriate start-up process being connected in between. By briefly switching on the second suction valve 64, any air bubbles in the print head 70 are “hammered out”. Accordingly, air bubbles can be removed from the print head 70. It should also be pointed out that the ink holding valve 66 is locked in the non-energized state, thereby preventing the ink from running out if the vacuum pressure in a tank (not illustrated) in which the vacuum pressure prevails, gradually drops due to unsealed points when the machine is switched off.

The process of sucking ink out of the print head 70 in the cleaning unit proposed by the invention operates as follows. By means of a system consisting of the capacity of the waste ink bottle 74 and a throttle (not illustrated), a vacuum pressure prevailing in the tank 48 is applied, with a delay, to the print head 70. In this connection, it should be pointed out that the cleaning unit is delimited from the print carriage illustrated in the top right-hand region of FIG. 5 by the broken lines shown in the bottom right-hand region of FIG. 5. To initiate suction, the blower valve 68 is energized so that a delayed vacuum pressure builds up in the waste ink bottle 74. This vacuum pressure is also applied at the print head 70 to suck out ink in a defined manner. When the blower valve 68 is switched off, the pressure in the waste ink bottle 74 is returned to ambient pressure, again delayed by the throttle (not illustrated).

1. Cleaning unit (10) for an ink jet printer with a suction and parking cap (16) having an orifice (20) which can be placed on a print head (24), characterised in that the orifice (18) can be placed on the print head (24) so as to totally prevent any light from getting in.

2. Cleaning unit as claimed in claim 1, characterised in that it has a light-proof cover which is preferably motor-driven or displaceable by a print carriage.

3. Cleaning unit as claimed in claim 1 or 2, characterised in that a vacuum pressure can be applied at the orifice (20) and a circuit for generating the vacuum pressure has a delay element of the first order.

4. Cleaning unit as claimed in at least one of the preceding claims, characterised in that it additionally has a wiper unit (26) having a deflector roll (34) with an absorbent cloth, preferably made from non-woven material, which can be raised and lowered.

5. Cleaning unit as claimed in claim 4, characterised in that an apex (30) of the roll (34) is placed on the print head outlets when the print head (24) and the deflector roll (34) are disposed in a wiping position.

6. Cleaning unit as claimed in claim 4, characterised in that an apex (30) of the roll (34) is located to the side, adjacent to the print head outlets, when the print head (24) and the deflector roll (34) are disposed in a wiping position.

7. Cleaning unit as claimed in at least one of the preceding claims, characterised in that the suction and parking cap (16) has a rinsing orifice (22) into which solvent can be introduced.

8. Cleaning unit as claimed in claim 7, characterised in that the suction and parking cap (16) are rotatable so that a suction orifice (20) or the rinsing orifice (22) can be selectively placed on the print head (24).

9. Cleaning unit (10) for an ink jet printer with one or more suction and parking caps (16) having an orifice (20) which can be placed on a print head (24), characterised in that the orifice (20, 22) can be placed on the print head (24) so as to totally prevent any light from getting in.

10. Cleaning unit as claimed in claim 9, characterised in that it has a light-proof cover which is preferably motor-driven or displaceable by a print carriage.

11. Cleaning unit as claimed in claim 9, characterised in that a vacuum pressure can be applied at the orifice (20) and a circuit for generating the vacuum pressure has a delay element of the first order.

12. Cleaning unit as claimed in claim 9, characterised in that it additionally has a wiper unit (26) having a deflector roll (34) with an absorbent cloth, preferably made from non-woven material, which can be raised and lowered.

13. Cleaning unit as claimed in claim 12, characterised in that an apex (30) of the roll (34) is placed on the print head outlets when the print head (24) and the deflector roll (34) are disposed in a wiping position.

14. Cleaning unit as claimed in claim 12, characterised in that an apex (30) of the roll (34) is located to the side, adjacent to the print head outlets, when the print head (24) and the deflector roll (34) are disposed in a wiping position.

15. Cleaning unit as claimed in claim 9, characterised in that the suction and parking cap (16) has a rinsing orifice (22) into which solvent can be introduced.

16. Cleaning unit as claimed in claim 15, characterised in that the suction and parking cap (16) are rotatable so that a suction orifice (20) or the rinsing orifice (22) can be selectively placed on the print head (24).
